(19) United States
(12) Patent Application Publication
(10) Pub. No.: US 2012/0191300 A1
(43) Pub. Date: Jul. 26, 2012

(54) OBSTACLE INDICATION AND AVOIDANCE

(76) Inventor: Pablo Adrian Mayo, Caba (AR)

(21) Appl. No.: 13/356,750

(22) Filed: Jan. 24, 2012

Related U.S. Application Data
(60) Provisional application No. 61/461,669, filed on Jan. 24, 2011.
(60) Provisional application No. 61/526,977, filed on Aug. 24, 2011.

(51) Int. Cl. G08G 1/16; B60Q 1/00

(52) U.S. Cl. 701/41; 340/435; 701/70

(57) ABSTRACT

A vehicle obstacle avoidance indicator system includes multiple beam sources, such as laser radiation sources, mounted on the vehicle and positioned to emit respective directed energy beams from the vehicle, such that the beams intersect at a visible intersection point spaced from the vehicle along a direction of travel. The driver may observe the intersection in low visibility conditions, and upon seeing the intersection disappear and replaced by spaced-apart termination points of the beams, determine that an obstacle is to be avoided.

### CROSS REFERENCE TO RELATED APPLICATIONS

This application is a non-provisional application that claims priority Under 35 U.S.C. 119e from U.S. Provisional Application Ser. No. 61/461,669 filed on Jan. 24, 2011 and U.S. Provisional Application Ser. No. 61/526,977 filed on Aug. 24, 2011 the disclosure of both of these provisional applications are hereby incorporated herein by reference in their entirety.

### TECHNICAL FIELD

This invention relates to obstacle indication and avoidance, and more particularly to an obstacle avoidance indicator system for safe operation of a moving vehicle.

### BACKGROUND

Limited visibility is a major contributor to the occurrence of vehicle accidents. In particular, an object located in a vehicular path of travel is often unobservable to a vehicle operator when visibility conditions are poor, which can lead to a vehicle collision with the object. Such objects may include debris of various types, stray animals, and other vehicles. Limited visibility of a vehicular path of travel can result from manmade conditions, such as insufficient roadway lighting, or from any number of natural conditions that increase air density, such as fog, rain, snow, etc. Conditions affecting collision accidents can furthermore involve a wide range of vehicles, including automobiles, trains, ships, and aircraft.

In total, vehicle collision accidents can have a significant impact on human life and public transportation conditions. Thus, there is a need for a vehicular safety device that can alert a vehicle operator to the presence of an object located in the vehicular path of travel during conditions of low visibility. Given that high air density is a key contributor to limited visibility, safety devices that exploit this property can be particularly suited to preventing vehicle collisions during conditions of low visibility.

### SUMMARY

The invention involves a realization that visible, directed beams of energy can be utilized to indicate the presence of an object spaced apart from a vehicle along a direction of travel.

One aspect of the invention features a method of indicating a presence of an object at a distance from a vehicle moving along a direction of travel. The method includes generating multiple energy beams extending from respective spaced-apart beam sources mounted on the moving vehicle so as to be visible to an operator of the moving vehicle. The method also includes directing the multiple energy beams in a downward direction to intersect at an approximated or common intersection point spaced-apart from the vehicle along the direction of travel and lower than the respective spaced-apart beam sources, such that a visible termination of the multiple energy beams between the vehicle and the common intersection point indicates the presence of the object.

The beam sources may be detachable, manually adjustable laser beams that may be configured to be emitted in different colors.

The beam sources may operate in a continuous or discontinuous manner.

One or more of the beam sources may be mounted on an external or internal surface of the vehicle, wherein that internal or external surface may belong to the vehicle illumination sources like fog lamps or normal driving headlights, and wherein the beam sources may be activated at the same time illumination sources are activated.

In some examples, the method further includes adjusting at least one of the beam sources as a function of a vehicle speed, thereby altering a distance of the common intersection point from the vehicle as a function of the vehicle speed.

In some cases, the adjusting is done automatically, based on a signal indicative of vehicle speed.

In some instances, the multiple energy beams are directed such that the common intersection point is disposed adjacent and above a flat roadway surface elevation forward of the vehicle.

Another aspect of the invention features a method of safely operating a vehicle moving along a direction of travel. The method includes monitoring a visible intersection between multiple energy beams emanating from respective, spaced-apart sources on the vehicle while operating the vehicle to move along the direction of travel. The visible intersection is disposed forward of the vehicle along the direction of travel. Upon observing the multiple energy beams terminate at respective, spaced-apart termination points at a distance closer than where the visible intersection would be in an absence of an interrupting object, the method includes altering a speed and/or a direction of the moving vehicle to prevent a collision with an object interrupting the multiple energy beams.

Another aspect of the invention features an obstacle avoidance indicator system (OATS) for a vehicle. The system includes a first beam source, mounted on the vehicle and positioned to emit a first directed energy beam from the vehicle, and a second beam source mounted on the vehicle in a spaced-apart relation to the first beam source. The second beam source is positioned to emit a second directed energy beam from the vehicle so as to intersect with the first directed energy beam at a visible intersection point spaced from the vehicle along a direction of travel. The first and second beam sources are arranged such that the visible intersection point is lower than the first and second beam sources.

In some examples, the first and second beam sources are positioned to emit the first and second energy beams in a direction rearward of the vehicle, so as to provide an indication to an operator of the following vehicle.

In some instances, the intersection point is located at or beyond a safe stopping distance from the vehicle, of between 8 and 12 meters for every 10 kilometers per hour of vehicle speed.

In some examples, the visible intersection point is disposed between 10 and 150 meters, or between 20 and 100 meters, from a nearest end of the vehicle. In some examples, at highway speeds the visible intersection point is disposed between 70 and 100 meters from the front of the vehicle.

In some cases, the beam sources are adjustable to adjust a distance of the visible intersection point from the vehicle.

In some instances, the beam sources are configured to automatically adjust the beam sources in response to a signal that varies with vehicle speed.

In some examples, the beam sources are manually adjustable.

In some cases, the beam sources are configured such that adjustment of the beam sources alters both a declination angle of the beam sources and an included angle between the emitted energy beams.

In some instances, the first and second beam sources are directed such that the visible intersection point is disposed adjacent and above a flat roadway surface elevation forward of the vehicle.

In some examples, the first and second beam sources are mounted such that the first and second energy beams emanate from a similar or superior height on the vehicle and from emanation points spaced-apart laterally on the vehicle.

In some cases, the first and second beam sources are detachable from the vehicle.

In some instances, the first and second beam sources are controlled to begin emitting upon activation of vehicle headlamps or fog lamps.

In some examples, the first and second energy beams include laser beams.

In some cases, the first and second beam sources are positioned to emit the first and second energy beams in a direction forward of the vehicle along the direction of travel.

In some instances, the OAIS further includes a third beam source mounted on the vehicle and positioned to emit a third directed energy beam in a direction rearward of the vehicle, and a fourth beam source mounted on the vehicle in a spaced-apart relation to the third beam source and positioned to emit a fourth directed energy beam in a direction rearward of the vehicle so as to intersect with the third directed energy beam at a second visible intersection point rearward of the vehicle moving along the direction of travel. The third and fourth beam sources are arranged such that the second visible intersection point will provide an indication to an operator of the second vehicle of the proximity of the vehicle on which the third and fourth beam sources are mounted.

In some examples, any of the first, second, third or fourth beam sources are configured to emit energy beams of different colors.

An OAIS can be mounted on any of several types of transportation vehicles, including automobiles, trains, ships, and aircraft.

Various embodiments of the system will thus facilitate the safe operation of moving vehicles, by providing an indication of an object in the direction of travel and within a proximity that may cause a safety concern should the operator not be alerted. In many cases, the indication is a very simple elimination of a visible intersection between multiple beams emanating from the vehicle, which may occur before the object breaking the beams itself becomes visible. This may advantageously give the operator a greater time to respond by braking or redirecting the vehicle.

The details of one or more embodiments of the invention are set forth in the accompanying drawings and the description below. Other features, aspects, and advantages of the invention will be apparent from the description, drawings, and claims.

### BRIEF DESCRIPTION OF THE DRAWINGS

FIG. 1 is a top view of an obstacle avoidance indicator system (OATS) as mounted on a vehicle in a forward direction.

FIG. 2 is an example view of directed energy beams and a visible approximated or intersection point from the perspective a vehicle operator seated within a vehicle.

FIG. 3 is a side view of an OAIS as mounted on a vehicle.

FIG. 4 is a top view of an OAIS as mounted on a vehicle and interrupted by an object.

FIG. 5 is an image of a view of the beams interrupted by an object, as seen by the vehicle operator.

FIG. 6 is a top view of an OAIS as mounted on a vehicle in a rearward direction.

FIG. 7 is an image of directed beams of energy and a visible intersection point from the perspective a vehicle operator seated within a following vehicle.

FIG. 8 is a side view of an OAIS as mounted on a vehicle in a rearward direction, with the beams impinging upon a following vehicle.

FIGS. 9A-9C illustrate three examples of beam source mounting locations for a forward-facing OAIS.

FIG. 10 is a top view of an OAIS with four beam sources.

FIG. 11 is a side view of an OAIS as mounted on a vehicle and including both forward directed beam sources and rearward directed beam sources.

FIG. 12 is a perspective view of an OAIS mounted on a ship and in a forward direction.

FIG. 13 is a perspective view of an OAIS mounted on an aircraft.

Like reference symbols in the various figures indicate like elements.

### DETAILED DESCRIPTION

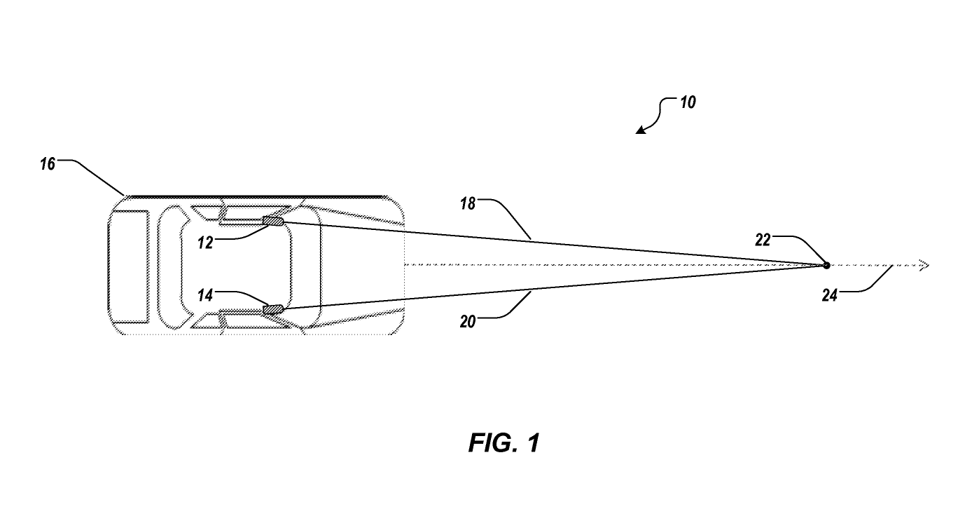

Referring first to FIG. 1, an obstacle avoidance indicator system (OATS) 10 includes a first beam source 12 and a second beam source 14 that are spaced-apart from one another and mounted on the exterior surface of a vehicle 16. The first beam source 12 is positioned to emit a first directed energy beam 18 from the vehicle. The second beam source 14 is positioned to emit a second directed energy beam 20 from the vehicle so as to intersect with the first beam 18 at a visible intersection point 22 spaced from the vehicle along a direction of travel 24. Each of the directed beams 18 and 20 and their approximated or intersection point 22 are visible to the vehicle operator.

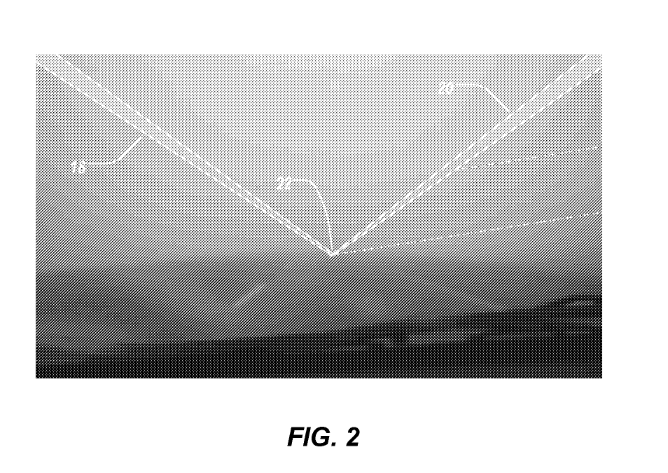

FIG. 2 displays an example view of directed energy beams 18 and 20 and their visible intersection point 22, from the perspective of a vehicle operator seated within the vehicle. As emitted from the beam sources, directed beams 18 and 20 form fixed segments that remain visible, intact, and terminate at visible intersection point 22 unless an interrupting object intersects the beams at a location between the vehicle and visible intersection point 22.

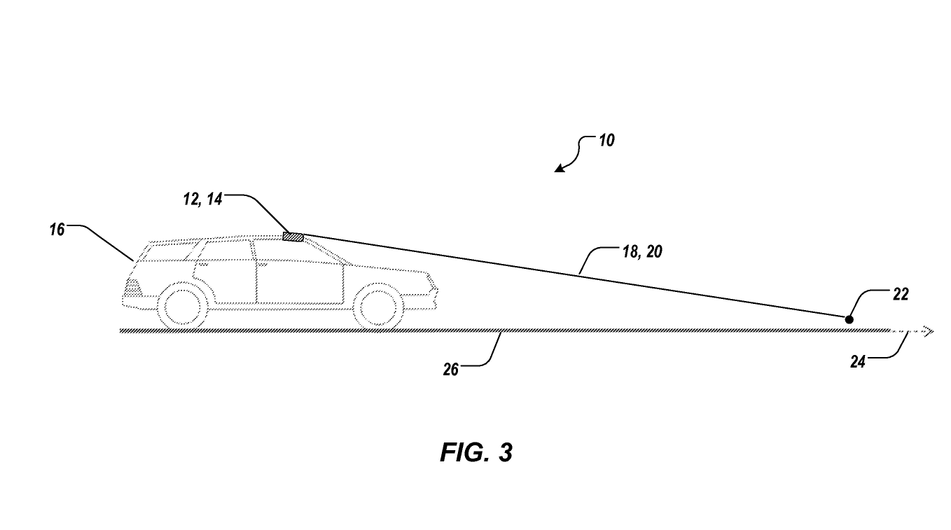

Now referring to FIG. 3, beam sources 12 and 14 are arranged to emit their respective beams 18 and 20 in a downward direction. Therefore, visible intersection point 22 is positioned lower than beam sources 12 and 14, with respect to the vehicle as driving along a flat road surface. As illustrated, beam sources 12 and 14 may be mounted on vehicle 16 such that beams 18 and 20 emanate from a similar height and from points spaced-apart laterally on the vehicle.

Beam sources 12 and 14 of this example are directed such that intersection point 22 is disposed adjacent and above a flat roadway surface elevation 26 forward of vehicle 16. Directing the beams such that intersection point 22 is at or slightly above the road surface will minimize the length of the beams beyond their intersection and will help to reduce the likelihood that the beams would extend to oncoming traffic. The angle of declination of the beams as shown in FIG. 3 is for illustration only; in many cases, the beams will extend much farther from the vehicle before intersecting.

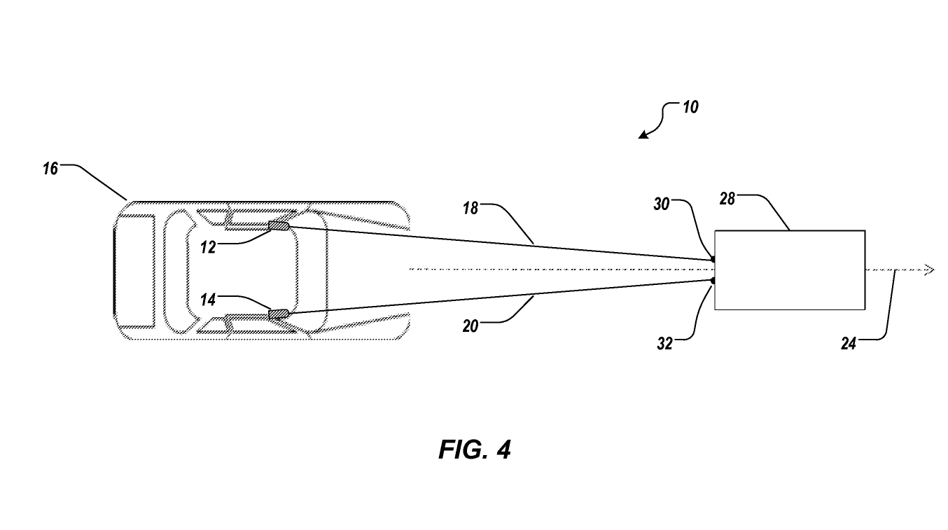

As shown in FIG. 4, intersection of an object 28 with beams 18 and 20 causes the beams to terminate at respective visible spaced-apart termination points 30 and 32 on the object. Therefore, upon such an occurrence, the visible intersection point disappears from the view of the vehicle operator. While monitoring the visible beams, either the disappearance of the visible intersection point and/or the appearance of visible spaced-apart termination points 30 and 32 serves as an indicator to the vehicle operator that object 28 is present forward of the vehicle along direction of travel 24. The vehicle operator can subsequently alter the speed of the vehicle and/or change the direction of vehicle travel in order to avoid a collision with object 28, which may be, for example, a piece of debris, a stray animal, a person, or another vehicle.

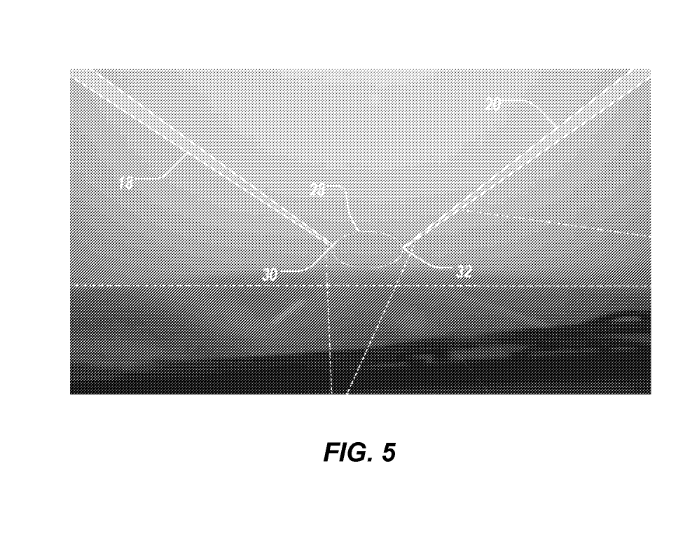

FIG. 5 shows what the operator may see upon interruption of the beams as in FIG. 4, showing termination of the beams at spaced-apart termination points 30 and 32.

Referring again to FIGS. 1 and 4, visible intersection point 22 is preferably located at a safe stopping distance from the vehicle, such as in a range of 8 to 12 meters for every 10 kilometers per hour of the vehicle speed. In some examples, intersection point 22 is located between 10 and 150 meters from a nearest end of the vehicle. In some instances, beam sources 12 and 14 are adjustable as a function of vehicle speed, such that the distance between visible intersection point 22 and vehicle 16 is a function of vehicle speed, increasing at higher speeds. Beam sources 12 and 14 may include declination adjustment motors, for example, that are controlled as a function of a signal received from a vehicle speed sensor. Alternatively, a manual manipulable declination controller may be provided, thereby permitting the operator to adjust the distance to intersection point 22, within safe limits.

Beam sources 12 and 14 may be controlled to automatically turn on as a function of a signal from a visibility sensor, or upon illumination of vehicle fog lamps or normal driving headlights, or by manual operation of a switch by the vehicle operator. Beam sources 12 and 14 may operate continuously or on an intermittent basis.

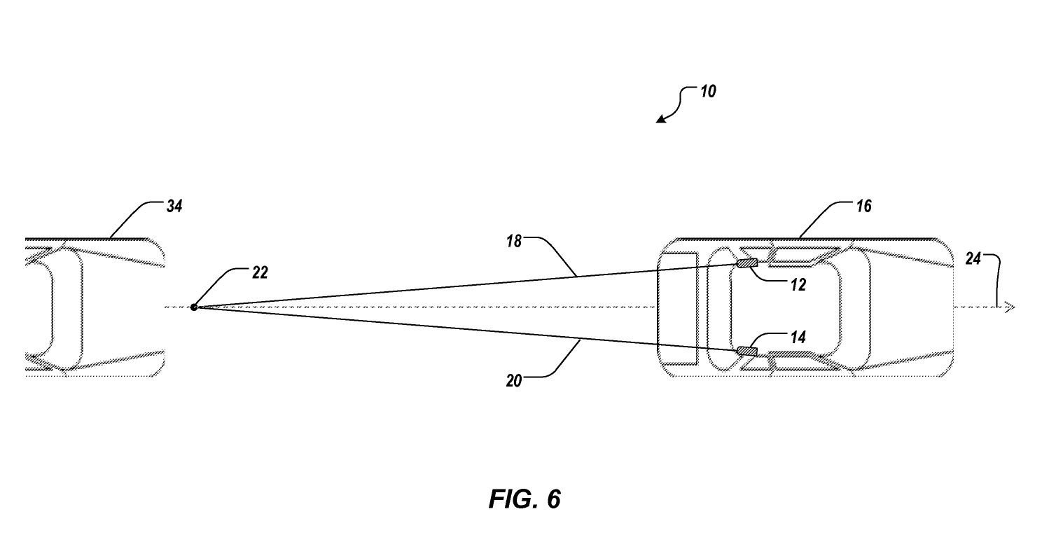

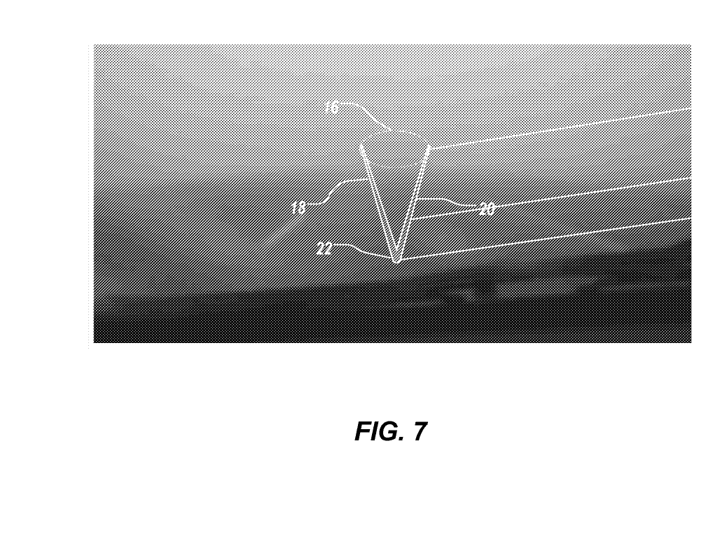

As shown in the top view of FIG. 6, in another example, beam sources 12 and 14 are positioned to emit beams 18 and 20 in a direction rearward of vehicle 16, so as to serve as an indicator of the presence of vehicle 16 to an operator of a following vehicle 34. An example view of such beams 18 and 20 and their intersection 22, from the viewpoint of the operator of the following vehicle, is shown in FIG. 7.

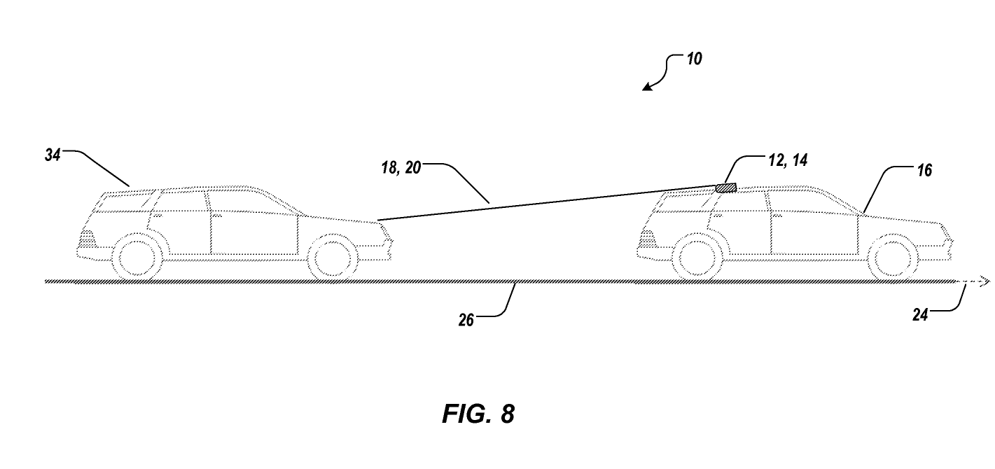

Beams 18 and 20 and their intersection 22 near the road surface may serve as sufficient indication of the proximity of the leading vehicle 16. Alternatively, rearward-directed beams 18 and 20 may be directed at a declination angle selected such that they will impinge upon the hood of following vehicle 34 when the vehicles 16 and 34 are spaced at a distance at which, determined by the speed of vehicles 16 and 34 along the road, the driver of following vehicle 34 should be alerted to the proximity of lead vehicle 16, as shown in FIG. 8. If beams 18 and 20 are directed so as to intersect at a lower elevation, beams 18 and 20 will be spaced apart on the hood of following vehicle 34. As with forward-facing energy beams, the declination angle of beams 18 and 20 in this example may be adjusted as a function of vehicle speed.

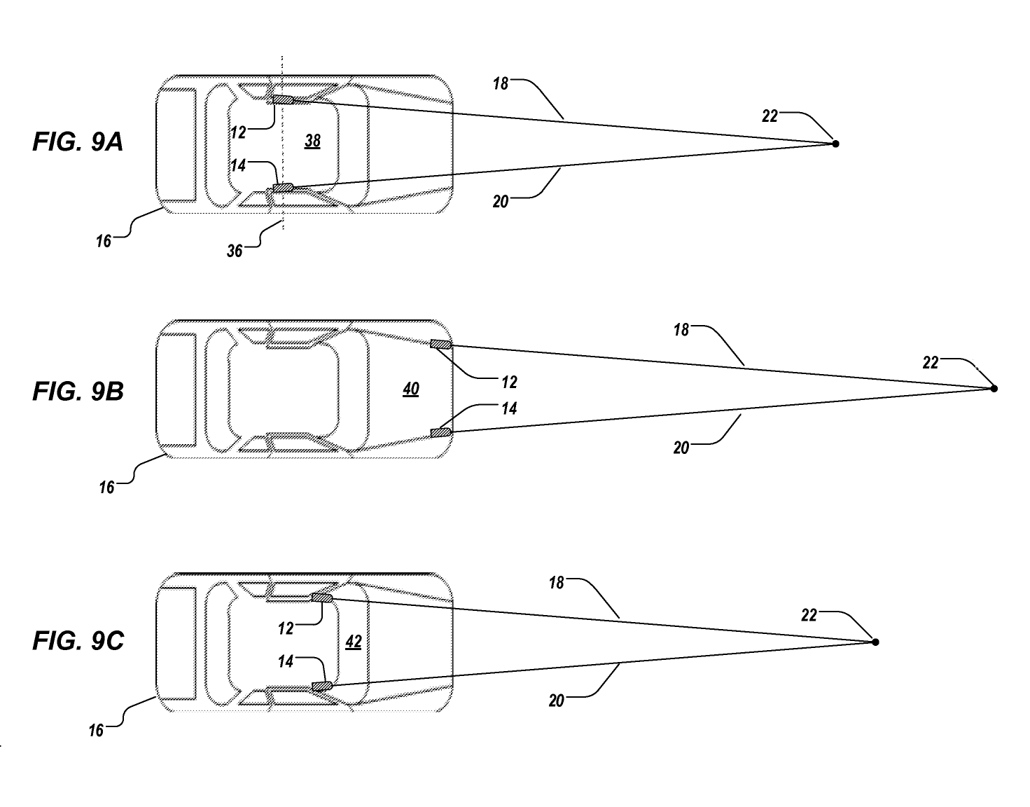

FIGS. 9A-9C illustrate various beam source mounting positions. In the example of FIG. 9A, beam sources 12 and 14 are mounted along a lateral axis 36 on a roof surface 38 of vehicle 16, near the fore-aft location of the head of the operator. In the example of FIG. 9B, beam sources 12 and 14 are mounted near respective forward corners of the hood 40, near the front end of vehicle 16. In the example of FIG. 9C, beam sources 12 and 14 are mounted near an intersection of the roof and the front windshield 42 of vehicle 16. Mounting beam sources 12 and 14 to be at a height at or near the height of the operator's eyes can advantageously cause any extension of the beams 18 and 20 beyond their intersection 22 to be blocked from the operator's view by the nearer portions of beams 18 and 20.

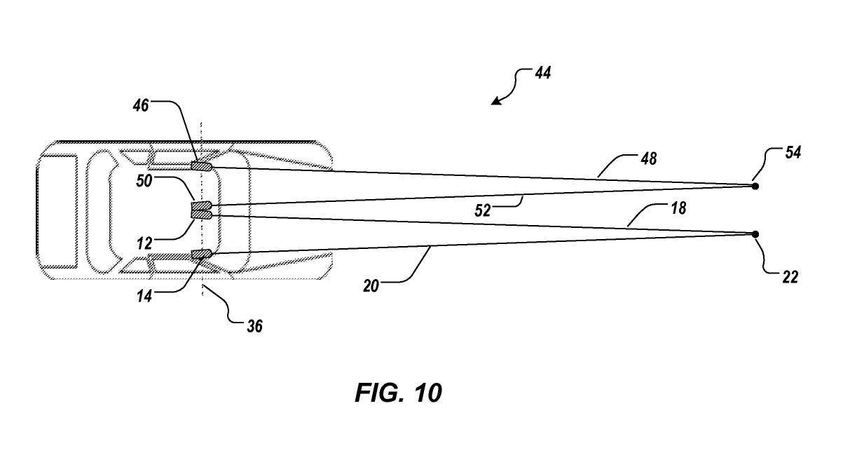

In some examples, the OAIS may have more than two beam sources. For example, OAIS 44 of FIG. 10 includes third and fourth beam sources 46 and 50 mounted on the vehicle and positioned to emit respective third and fourth energy beams 48 and 52 in a direction forward of the vehicle. Beams 48 and 52 are directed to intersect at a second visible intersection point 54 spaced from the vehicle and along a direction of travel. Beam sources 12, 14, 46 and 50 are all shown located along a common position axis 36. The beams may be directed such that intersection points 54 and 22 are at a similar distance from the vehicle, as shown, or may be directed such that one intersection point occurs nearer the vehicle, and the other farther from the vehicle. Beams 18, 20, 48 and 52 may be of different colors, such that one set of beams 18 and 20 is of one color to provide an indication of objects at one distance, and the other set of beams 48 and 52 is of another color and provides a separate and simultaneous indication of objects at another distance, for example.

In some embodiments, any of beam sources 12, 14, 46 and/or 50 may be mounted within an interior region of the vehicle.

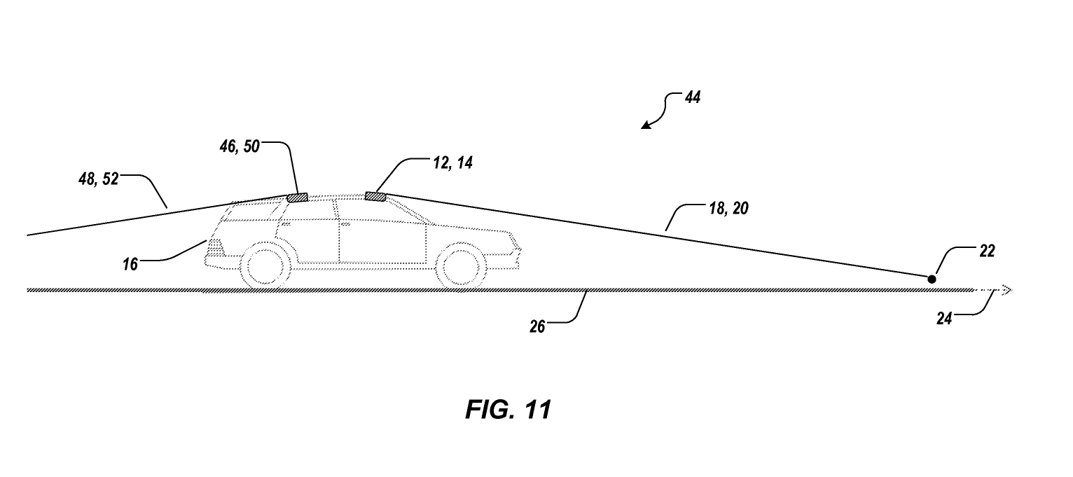

As shown in FIG. 11, an OAIS 44 may be configured to direct beams both forward and rearward of the same vehicle 16. In this example, third and fourth beam sources 46 and 50 emit energy beams 48 and 52 rearward of vehicle 16, while beam sources 12 and 14 emit beams 18 and 20 forward of vehicle 16. In this case, the visible intersection point of the rearward-directed beams serves as an indicator to the operator of a following vehicle (not shown), while visible intersection point 22 of forward-directed beams 18 and 20 serves as an indicator to the operator of vehicle 16. Beams 48 and 52 may be of a same color as beams 18 and 20, or may be of a different color chosen to differentiate them from forward-directed beams.

Any or all of the various beam sources discussed above may be laser beam sources, for example. The beam color, diameter and intensity are chosen such that the beams themselves will be visible to the vehicle operator in low visibility conditions, as partially reflected by particles in the air. Such particles may be water particles from fog or rain, or ice particles from snow, or from dust, smoke or smog, for example. As the density of particles within the air increases, a greater proportion of beams 16, 18, 48, and 52 will be reflected between the vehicle and their intersection points, making the beams themselves appear brighter. Beam intensity should be sufficient, however, to render the beam intersection point visible in reasonably severe atmospheric conditions.

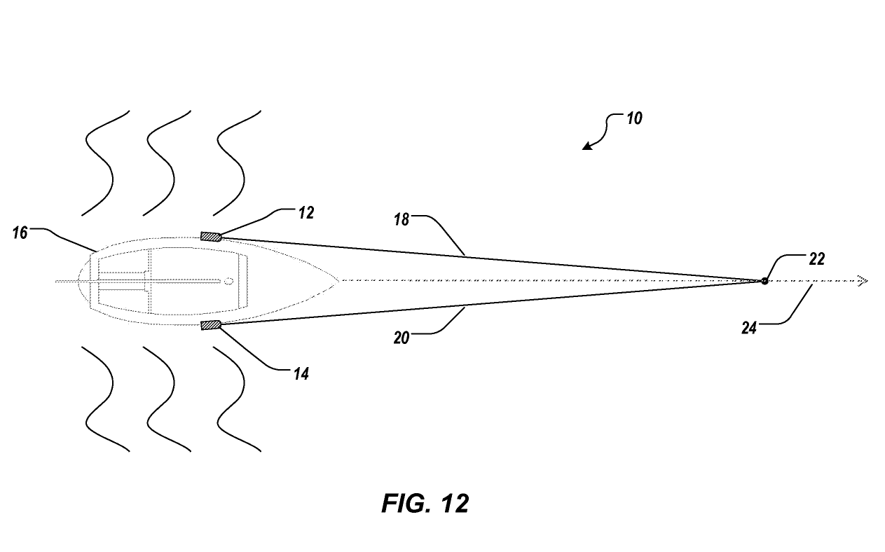

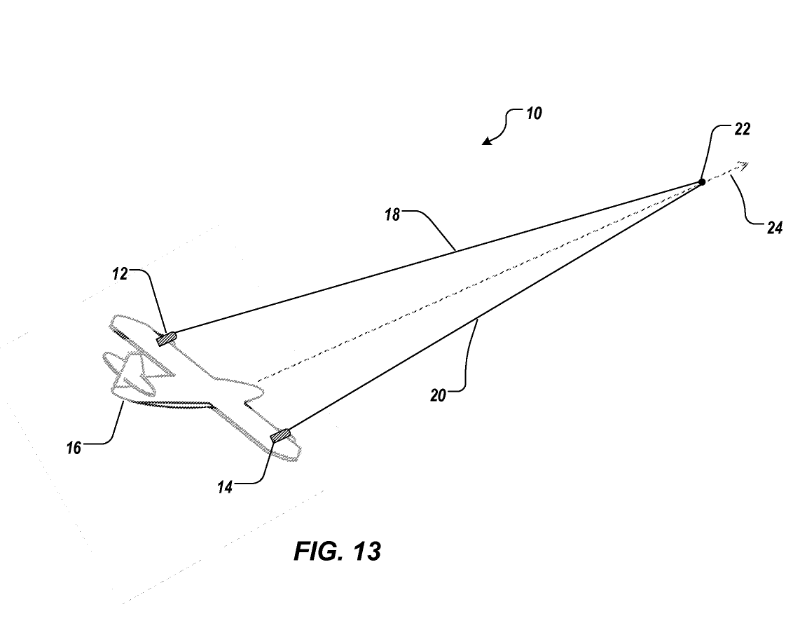

While the above examples have been described with respect to road-based vehicles, such as cars or trucks, the obstacle avoidance indication systems may also be configured for use with other types of operated vehicles. For example, FIG. 12 shows an OAIS 10 mounted on a vehicle 16 in the form of a boat or ship. In such a case, beams 18 and 20 would be directed such that intersection point 22 occurs forward of the ship along direction of travel 24. The declination angle of beams 18 and 20 may be adjusted to avoid interference from waves. FIG. 13 shows an example of an OAIS 10 mounted on an airborne vehicle 16 in the form of an aircraft.

The systems described above may be provided as original vehicle equipment, or may be retrofitted to existing vehicles. They may also be configured to be moved from vehicle to vehicle, or removed from the vehicle when not in use. In such cases, the beam sources may be mounted magnetically or with suction cups or the like.

While a number of examples have been described for illustration purposes, the foregoing description is not intended to limit the scope of the invention, which is defined by the scope of the appended claims. There are and will be other examples and modifications within the scope of the following claims.

What is claimed is:

1. A method of indicating a presence of an object at a distance from a vehicle moving along a direction of travel, the method comprising:
generating multiple energy beams extending from respective spaced-apart beam sources mounted on the moving vehicle so as to be visible to an operator of the moving vehicle; and directing the multiple energy beams in a downward direction to intersect at a common intersection point spaced-apart from the vehicle along the direction of travel and lower than the respective spaced-apart beam sources, such that a visible termination of the multiple energy beams between the vehicle and the common intersection point indicates the presence of the object.

2. The method of claim 1, further comprising adjusting at least one of the beam sources as a function of vehicle speed, thereby altering a distance of the common intersection point from the vehicle as a function of vehicle speed.

3. The method of claim 1 or claim 2, wherein the adjusting is done automatically, based on a signal indicative of vehicle speed.

4. The method of any of the above claims, wherein the multiple energy beams are directed such that the common intersection point is disposed adjacent and above a flat roadway surface elevation forward of the vehicle.

5. A method of safely operating a vehicle moving along a direction of travel, the method comprising:
monitoring a visible intersection between multiple energy beams emanating from respective, spaced-apart sources on the vehicle while operating the vehicle to move along the direction of travel, the visible intersection disposed forward of the vehicle along the direction of travel; and
upon observing the multiple energy beams terminate at respective, spaced-apart termination points at a distance closer than where the visible intersection would be in an absence of an interrupting object, altering a speed and/or a direction of the moving vehicle to attempt to prevent a collision with an object interrupting the multiple energy beams.

6. An obstacle avoidance indicator system for a vehicle, the system comprising:
a first beam source mounted on the vehicle and positioned to emit a first directed energy beam from the vehicle; and
a second beam source mounted on the vehicle in a spaced-apart relation to the first beam source, the second beam source positioned to emit a second directed energy beam from the vehicle so as to intersect with the first directed energy beam at a visible intersection point spaced from the vehicle along a direction of travel,
wherein the first and second beam sources are arranged such that the visible intersection point is lower than the first and second beam sources.

7. The system of claim 6, wherein the first and second beam sources are positioned to emit the first and second energy beams in a direction rearward of the vehicle, so as to provide an indication to an operator of the following vehicle.

8. The system of claim 6, configured to automatically adjust the beam sources in response to a signal that varies with vehicle speed.

9. The system of any of claim 6, configured such that an adjustment of the beam sources alters both a declination angle of the beam sources and an included angle between the emitted energy beams.

10. The system of any of claim 6, wherein the first and second beam sources are directed such that the visible intersection point is disposed adjacent and above a flat roadway surface elevation forward of the vehicle.

11. The system of any of claim 6, wherein the first and second beam sources are mounted such that the first and second directed energy beams emanate from a similar height on the vehicle and from emanation points spaced-apart laterally on the vehicle.

12. The system of any of claim 6, wherein the first and second beam sources are positioned to emit the first and second directed energy beams in a direction forward of the vehicle along the direction of travel, and wherein the first and second beam sources are controlled to begin emitting upon activation of vehicle headlamps or fog lamps.

13. The system of claim 12, further comprising:
a third beam source mounted on the vehicle and positioned to emit a third directed energy beam in a direction rearward of the vehicle; and
a fourth beam source mounted on the vehicle in a spaced-apart relation to the third beam source and positioned to emit a fourth directed energy beam in a direction rearward of the vehicle so as to intersect with the third directed energy beam at a second visible intersection point rearward of the vehicle moving along the direction of travel, so as to provide an indication to an operator of the second vehicle of the proximity of the vehicle on which the third and fourth beam sources are mounted.

14. The system of any of claim 6, wherein the beam sources are detachable, manually adjustable laser beams configured to be emitted in different colors.

15. The system of any of claim 6, wherein the beam sources operate in a continuous or discontinuous manner, and wherein one or more of the beam sources are mounted on an internal or external surface of the vehicle, wherein that internal or external surface may belong to the vehicle illumination sources.
